(19) United States
(12) Patent Application Publication
(10) Pub. No.: US 2024/0109667 A1
(43) Pub. Date: Apr. 4, 2024

(54) PROPULSION ASSEMBLY FOR AN AIRCRAFT

(71) Applicants: Airbus SAS, BLAGNAC (FR); Airbus Operations SAS, TOULOUSE (FR)

(72) Inventors: Lionel CZAPLA, TOULOUSE (FR); Alexis PISSAVIN, BLAGNAC (FR)

(21) Appl. No.: 18/476,579

(22) Filed: Sep. 28, 2023

(30) Foreign Application Priority Data
Sep. 30, 2022 (FR) 2209988

(51) Int. Cl. B64D 37/30; B64D 27/12; F02C 7/22

(52) U.S. Cl. CPC B64D 37/30; B64D 27/12; F02C 7/22

(57) ABSTRACT

A propulsion assembly for an aircraft, which has a propulsion system with a combustion chamber surrounded by a casing, a supply pipe that conveys dihydrogen to the combustion chamber through the casing via injectors, and a housing fastened to the casing in a sealed manner around the latter, wherein the supply pipe has a downstream part housed inside the housing and wherein the injectors are also housed inside the housing.

### CROSS-REFERENCES TO RELATED APPLICATIONS

This application claims the benefit of French Patent Application Number 2209988 filed on Sep. 30, 2022, the entire disclosure of which is incorporated herein by way of reference.

### FIELD OF THE INVENTION

The present invention relates to a propulsion assembly for an aircraft, said propulsion assembly comprising a chassis fastened to a structure of a wing of the aircraft, a propulsion system such as a turboprop engine, which is fastened to the chassis, a dihydrogen pipe that supplies the combustion chamber of the propulsion system with said dihydrogen at injectors and a protective housing fastened in a sealed manner around the combustion chamber and surrounding the dihydrogen pipe and the injectors. The invention also relates to an aircraft having at least one such propulsion assembly.

### BACKGROUND OF THE INVENTION

In order to move, an aircraft conventionally has at least one propulsion assembly comprising a propulsion system such as a turboprop engine. Such a propulsion system has a core that is enclosed in a casing and that has, inter alia, from upstream to downstream, a compressor, a combustion chamber and a turbine. The propulsion system also has a propeller driven in rotation by the core. The compressor and the turbine each have blades that are fastened to a rotary shaft.

The propulsion assembly also has a chassis that is fastened to a structure of the wing of the aircraft and thus constitutes an attachment pylon beneath the wing.

In order to limit pollution due to the use of kerosene, using dihydrogen as fuel in the combustion chamber is envisaged.

This dihydrogen is brought from a tank to the combustion chamber by a dihydrogen pipe that extends at least partially in the propulsion assembly. As a result of the structure of the propulsion assembly and its position beneath the wing and on the front of the wing, the dihydrogen pipe passes through the chassis, coming from the wing, and thus runs from the rear to the front as far as the combustion chamber.

In order to limit the impact of the temperature of the core on the dihydrogen pipe, the latter runs outside the casing so as to reach the combustion chamber through the casing at one or more injectors.

In the event of an incident at the dihydrogen pipe or the injectors, it is necessary to provide safety systems.

### SUMMARY OF THE INVENTION

An object of the present invention is to propose a propulsion assembly that has a housing fastened in a sealed manner around the combustion chamber and surrounding the dihydrogen pipe and the injectors in order to limit the propagation of the dihydrogen in the event of an incident.

To that end, there is proposed a propulsion assembly for an aircraft, having:
a propulsion system having a core enclosed in a casing and having a combustion chamber,
at least one supply pipe intended to convey dihydrogen to the combustion chamber wherein said at least one supply pipe meanders outside the casing before dropping into the combustion chamber through the casing via at least one injector, and
a housing fastened to the casing in a sealed manner around the latter,
wherein said at least one supply pipe has an upstream part and a downstream part that are fluidically connected to one another through a wall of the housing, wherein the upstream part is intended to be fluidically connected to a tank and fastened in a sealed manner to said wall of the housing and wherein the downstream part is housed inside the housing and fastened in a sealed manner to said wall of the housing and wherein the at least one injector is also housed inside the housing.

With such an arrangement, the dihydrogen is confined in the housing.

Advantageously, the propulsion assembly has at least one dihydrogen detector arranged in the housing, a control unit connected to said at least one detector and a solenoid valve mounted on the supply pipe and commanded to open and close by said control unit according to the data transmitted by said at least one detector.

According to one particular embodiment, the housing is constituted of two shells that are fastened in a sealed manner to one another at a vertical median plane P of the propulsion assembly, thus forming a volume between the two shells and the casing.

According to one particular embodiment, the housing is constituted of two shells wherein each one is fastened in a sealed manner to the casing at a plane parallel to a vertical median plane P of the propulsion assembly, forming, between each shell and the casing, a volume.

Advantageously, said or each downstream part is fluidically connected to an upstream part by a plurality of connection zones.

Advantageously, the housing is filled with dinitrogen.

Advantageously, for each volume, the propulsion assembly has an inlet pipe and an outlet pipe that are fluidically connected to said volume, wherein the inlet pipe is intended to introduce the dinitrogen into said volume and wherein the outlet pipe is intended to extract the dinitrogen from said volume.

Advantageously, the propulsion assembly has at least one dihydrogen detector arranged in the housing, a control unit connected to said at least one detector and a solenoid valve mounted on the supply pipe and commanded to open and close by said control unit according to the data transmitted by said at least one detector, and the propulsion assembly has, for each volume, at least one ignition means housed in said volume and controlled by the control unit so as to generate a spark when a dihydrogen detector of said volume detects dihydrogen.

The invention also proposes an aircraft having a wing, a dihydrogen tank, at least one propulsion assembly according to one of the variants, and, for each propulsion assembly, a chassis wherein the propulsion assembly is fastened to the chassis that is fastened to the wing and wherein said at least one supply pipe is fluidically connected to the dihydrogen tank.

### BRIEF DESCRIPTION OF THE DRAWINGS

The abovementioned features of the invention, along with others, will become more clearly apparent upon reading the following description of one exemplary embodiment, said description being given with reference to the appended drawings, in which:

FIG. 1 is a side view of an aircraft having a propulsion assembly according to the invention,

FIG. 2 is a schematic side depiction of a propulsion system of the propulsion assembly according to the invention,

FIG. 3 is a schematic depiction in section along the line III-III of a propulsion assembly according to a first variant embodiment of the invention,

FIG. 4 is a schematic depiction in section along the line III-III of a propulsion assembly according to a second variant embodiment of the invention,

FIG. 5 is a schematic depiction in section along the line III-III of a propulsion assembly according to a third variant embodiment of the invention,

FIG. 6 is a schematic depiction in section along the line III-III of a propulsion assembly according to a fourth variant embodiment of the invention,

FIG. 7 is a schematic depiction in section along the line III-III of a propulsion assembly according to a fifth variant embodiment of the invention, and

FIG. 8 is an schematic depiction of a connection implemented in the invention.

### DETAILED DESCRIPTION OF THE PREFERRED EMBODIMENTS

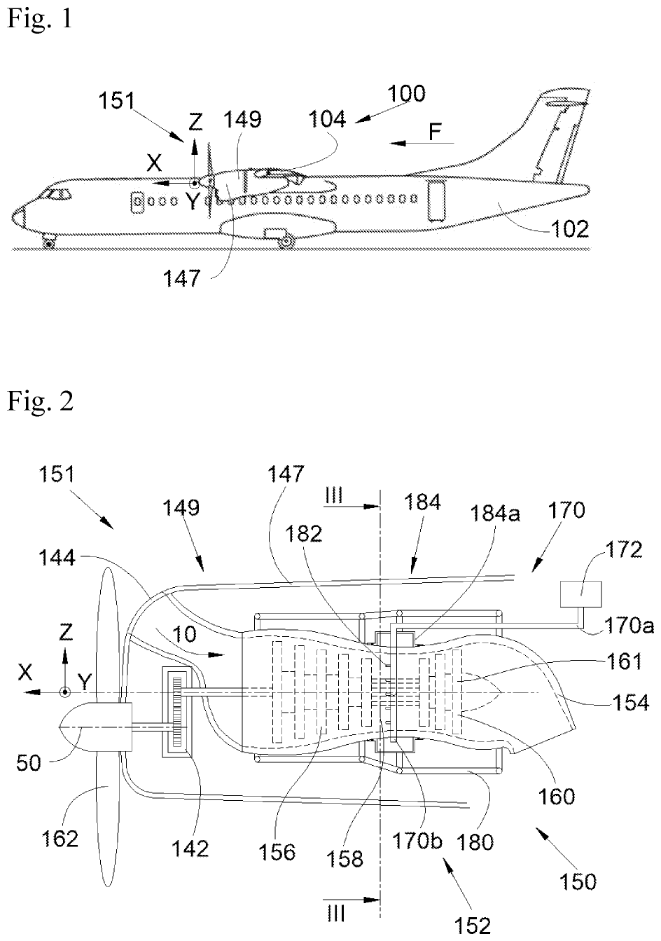

In the following description, terms relating to a position are considered in relation to an aircraft in a position of forward movement, i.e. as shown in FIG. 1 in which the arrow F shows the direction of forward movement of the aircraft.

In the following description, and by convention, X denotes the longitudinal axis of the propulsion system, which is parallel to the longitudinal axis of the aircraft oriented positively towards the front in the direction of forward movement of the aircraft, Y denotes the transverse axis, which is horizontal when the aircraft is on the ground, and Z denotes the vertical axis or vertical height when the aircraft is on the ground, these three axes X, Y and Z being mutually orthogonal.

FIG. 1 shows an aircraft 100 that has a fuselage 102 on either side of which is fastened a wing 104. Beneath each wing 104 is fastened at least one propulsion assembly 151 that has a nacelle 149 constituted of cowls 147 forming an aerodynamic outer surface.

FIG. 2 shows the propulsion assembly 151, which also has a propulsion system 150 that is depicted schematically.

For each propulsion assembly 151, the aircraft 100 has a chassis 180 to which the propulsion assembly 151 is fastened and that is fastened to a structure of the wing 104. The chassis 180 constitutes an attachment pylon. In the embodiment of the invention that is presented in FIG. 2, the chassis 180 takes the form of a cage constituted, inter alia, of beams fastened to one another. The chassis 180 is fastened to the structure of the wing by fastening means known to those skilled in the art.

In the embodiment of the invention that is presented in FIG. 2, the propulsion system 150 is a turboprop engine that has a core 152 that is enclosed in a casing 154. In the embodiment of the invention that is presented in FIG. 2, the casing 154 is housed inside the chassis 180 forming a cage and it is fastened thereto by any suitable means known to those skilled in the art.

External air enters the nacelle 149 through an opening 144 provided in the cowls 147 at the front of the nacelle 149.

Inside the nacelle 149, the primary air flow 10 enters the core 152 so as to supply the combustion chamber 158 with dioxygen.

The casing 154 is thus open at the front so as to allow the introduction of the primary flow 10 into the core 152 and open at the rear to allow the gases originating from the combustion to escape through a nozzle. The core 152 has, from upstream to downstream, a compressor 156, a combustion chamber 158 and a turbine 160. The compressor 156 and the turbine 160 are provided with blades 161 that rotate about the longitudinal axis X.

The primary flow 10 thus passes successively through the compressor 156 where it is compressed before being injected into the combustion chamber 158 where it is mixed with the fuel. The gases originating from the combustion then pass through the turbine 160 and drive it in rotation. The turbine 160 then in turn drives the compressor 156 in rotation and the gases are then ejected at the rear.

The propulsion system 150 has a propeller 162 that is at the front and driven in rotation by the turbine 160. In the embodiment of the invention that is presented here, the propulsion system 150 also has a gearbox 142 mounted between the turbine 160 and the propeller 162 that rotates about a rotation axis 50 parallel to the longitudinal axis X and that in this case is offset with respect to the longitudinal axis X.

The propulsion assembly 151 also has at least one supply pipe 170 that makes it possible to convey dihydrogen as fuel to the combustion chamber 158, being fluidically connected to a dihydrogen tank 172 of the aircraft 100. Said at least one supply pipe 170 thus meanders outside the casing 154 before dropping into the combustion chamber 158 through the casing 154 via at least one injector 182.

In the event of an incident on the propulsion system 150, there may be dihydrogen leaks at the supply pipe 170 and/or the injectors 182.

In order to prevent dihydrogen from spreading everywhere, the propulsion assembly 151 has a housing 184 that is fastened to the casing 154 in a sealed manner around the latter, wherein the injectors 182 and at least a part of the supply pipe 170 are enclosed in said housing 184. The housing 184 is thus arranged around the combustion chamber 158.

In general, said at least one supply pipe 170 thus has an upstream part 170a and a downstream part 170b that are fluidically connected to one another through a wall (183, FIG. 8) of the housing 184.

The upstream part 170a is fluidically connected to the tank 172 and fastened in a sealed manner to the wall 183 of the housing 184 and the downstream part 170b that is housed inside the housing 184 is fastened in a sealed manner to the wall 183 of the housing 184. The downstream part 170b extends as far as the injectors 182 that are also housed in the housing 184.

Thus, in the event of an incident on the downstream part 170b or the injectors 182, the dihydrogen remains confined in the housing 184 and various measures can be taken to limit the concentration of dihydrogen in the housing 184 or the risk of explosion. FIG. 8 shows an example of sealed junction between the upstream part 170a and the wall 183 of the housing 184, on the one hand, and between the downstream part 170b and the wall 183 of the housing 184, on the other hand, at the passage through the wall 183 of the housing 184.

The upstream part 170a is as one with a flange 802 that is fastened to the outer face of the wall 183 by fastening means 804 such as clamping screws. In the same way, the downstream part 170b is as one with a flange 806 that is fastened to the inner face of the wall 183 by fastening means 808 such as clamping screws.

The upstream part 170a and the downstream part 170b are in fluidic communication via a bore 810 that passes through the wall 183 between its two faces.

Seals such as O-ring seals are put in place between the wall 183 and each flange 802, 806.

FIG. 8 also shows an example of fastening the housing 184 to the casing 154. The housing 184 is fastened against the casing 154 by fastening means 812 such as, for example, clamping screws and seals such as O-ring seals are arranged between the casing 154 and the housing 184.

In order to stop the arrival of dihydrogen in the downstream part 170b, the propulsion assembly 151 has at least one dihydrogen detector 820 that is arranged in the housing 184 and connected to a control unit 822 that itself controls the opening and closure of a solenoid valve 824 mounted on the supply pipe 170. The solenoid valve 824 is in this case mounted on the downstream part 170b, but it can also be mounted on the upstream part 170a.

Thus, according to the data transmitted by said at least one detector 820, the control unit 822 will command the opening (when dihydrogen is not detected) or the closure (when dihydrogen is detected) of the solenoid valve 824.

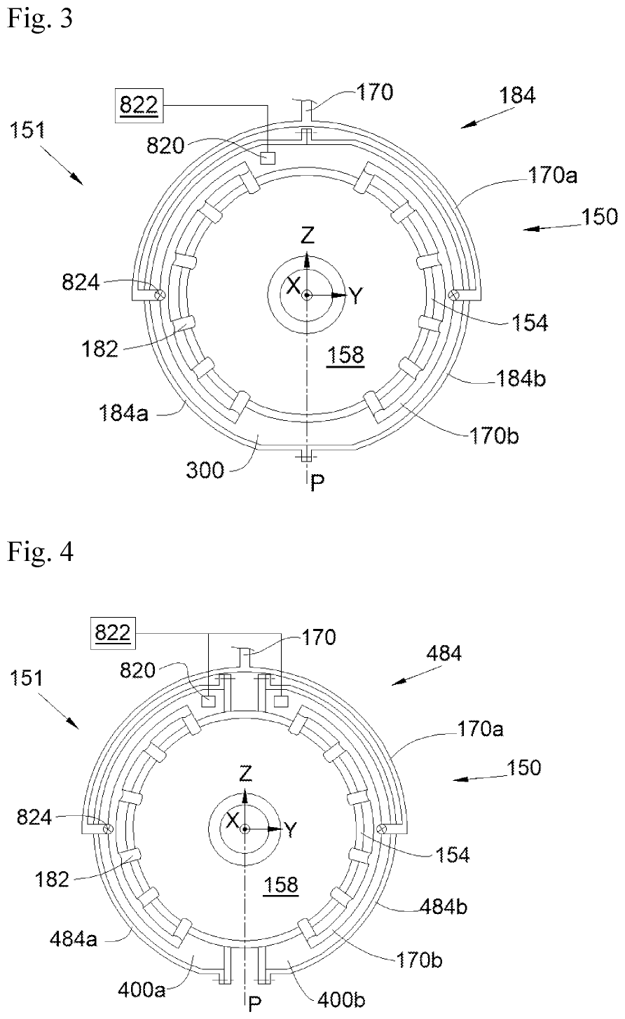

FIG. 3 shows a first embodiment of the invention, in which the housing 184 is constituted of two shells 184a-b that are fastened in a sealed manner to one another at a vertical median plane P (XZ) of the propulsion assembly 151 so as to form a closed ring around the casing 154. The two shells 184a-b are fastened by means of securing means such as clamping screws, rivets, etc. The two shells 184a-b delimit, with the casing 154, a single volume 300.

In FIG. 2, the shell 184b has been removed in order to reveal the supply pipe 170 and the injectors 182.

In the embodiment of the invention that is presented in FIG. 3, there are two downstream parts 170b that are disposed respectively on the port side and on the starboard side and each one is connected to an upstream part 170a respectively on the port side and on the starboard side, and there is also one solenoid valve 824 for each downstream part 170b. The two downstream parts 170b, the injectors 182 and in this case the two solenoid valves 824 are housed in the volume 300.

FIG. 4 shows a second embodiment of the invention, in which the housing 484 is constituted of two shells 484a-b that are separated from one another, and each one is fastened in a sealed manner to the casing 154 at a plane parallel to the vertical median plane P (XZ) of the propulsion assembly 151. There is thus one shell 484a on the port side and one shell 484b on the starboard side. The two shells 484a-b are fastened to the casing 154 by means of securing means such as clamping screws, rivets, etc. Each shell 484a-b and the casing 154 delimit between them a volume 400a-b and there are thus two separate volumes 400a-b.

In the embodiment of the invention that is presented in FIG. 4, there are two downstream parts 170b that are disposed on the port side and on the starboard side and each one is connected to an upstream part 170a respectively on the port side and on the starboard side, and there is also one solenoid valve 824 for each downstream part 170b.

Each volume 400a-b makes it possible to house one of the two downstream parts 170b, the associated injectors 182 and one of the two solenoid valves 824. In this embodiment, there is at least one dihydrogen detector 820 in each volume 400a-b.

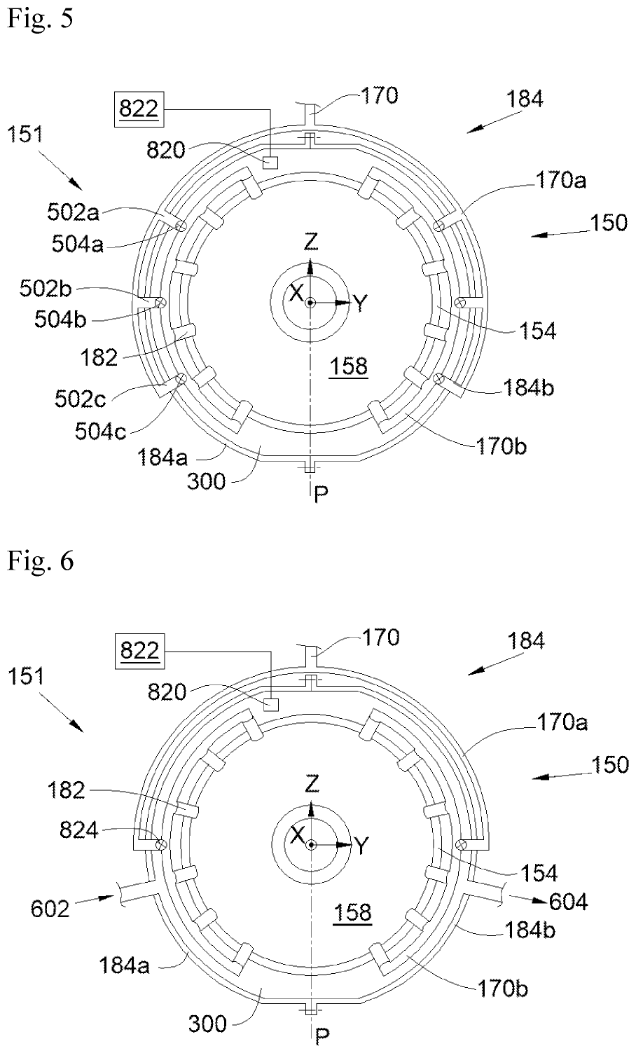

FIG. 5 shows a third embodiment of the invention, in which the housing 184 is similar to that of the first embodiment depicted in FIG. 3, but that could have a shape similar to the housing 484 of the second embodiment depicted in FIG. 4.

In the third embodiment, there are two downstream parts 170b, one on the port side and one on the starboard side, and each one is fluidically connected to an upstream part 170a by a plurality of connection zones 502a-c, which in this case are three in number per downstream part 170b, and in this case each connection zone 502a-c is equipped with a solenoid valve 504a-c controlled by the control unit 822.

In general, in order to limit the concentration of dihydrogen in the housing 184, 484, it is possible to fill said housing 184, 484 with a gas that is inert with respect to dihydrogen, such as dinitrogen for example. This particular embodiment is applied to all the embodiments described above.

FIG. 6 shows a fourth embodiment of the invention, in which the housing 184 is similar to that of the first embodiment depicted in FIG. 3, but that could have a shape similar to the housing 484 of the second embodiment depicted in FIG. 4. This fourth embodiment can also be applied to the third embodiment in FIG. 5.

In general, for each volume 300, 400a-b, the propulsion assembly 151 has an inlet pipe 602 through which the dinitrogen is introduced into said volume 300, 400a-b and an outlet pipe 604 through which the dinitrogen is extracted from said volume 300, 400a-b.

Each pipe 602, 604 is fluidically connected to the volume 300, 400a-b under consideration through the wall of the housing 184, 484.

The inlet pipe 602 is fluidically connected to a dinitrogen tank and to a pump that drives the dinitrogen in the inlet pipe 602 into the housing 184, 484 in order to generate a stream of dinitrogen in the housing 184, 484 and the dinitrogen at a raised pressure is evacuated via the outlet pipe 604 and returns for example to the dinitrogen tank.

In the case of the second embodiment of the invention that is presented in FIG. 4, there is one inlet pipe and one outlet pipe per shell 484a-b in order to generate a stream of dinitrogen in each shell 484a-b of the housing 484.

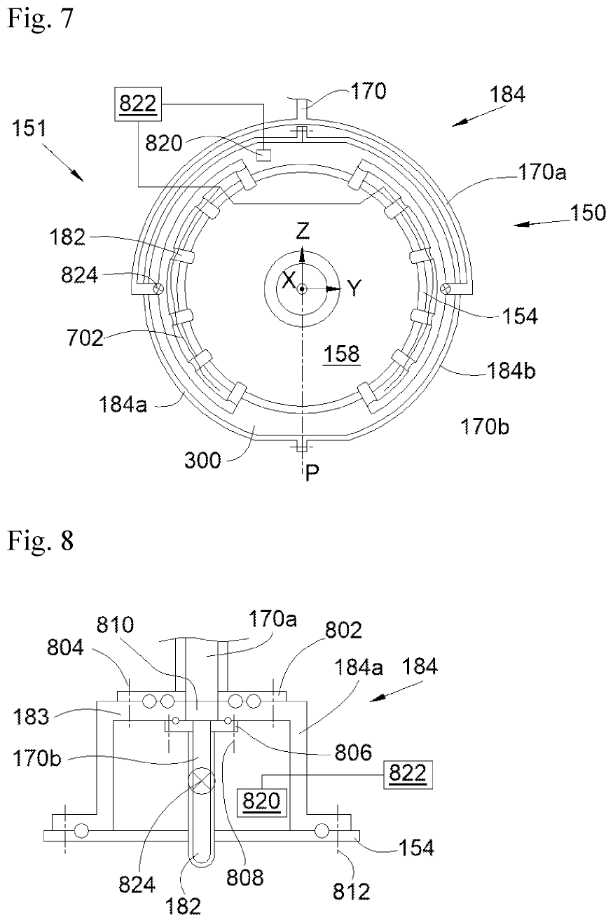

FIG. 7 shows a fifth embodiment of the invention, in which the housing 184 is similar to that of the first embodiment depicted in FIG. 3, but that could have a shape similar to the housing 484 of the second embodiment depicted in FIG. 4. This fifth embodiment can also be applied to the third embodiment in FIG. 5.

In order to limit the concentration of dihydrogen in each volume 300, 400a-b, the propulsion assembly 151 has, for each volume 300, 400a-b, at least one ignition means 702 that is housed in said volume 300, 400a-b and that is controlled by the control unit 822. The ignition means 702 generates at least one spark that sets light to the dihydrogen in order to burn it without it exploding. Thus, when dihydrogen is detected in a volume 300, 400a-b by a dihydrogen detector 820 of said volume 300, 400a-b, the control unit 822 controls the ignition means 702 housed in said volume 300, 400 a-b so that it generates a spark in said volume 300, 400a-b.

In the various embodiments of the invention that are presented here, there is a single injector rail per side, but it is possible to have a plurality of them per side, disposed one after another along the longitudinal axis X and housed in the same housing.

According to one embodiment, the control unit 822 has, connected by a communication bus: a processor or CPU (central processing unit); a random access memory (RAM); a read-only memory (ROM); a storage unit such as a hard disk or a storage medium reader, such as an SD (secure digital) card reader; at least one communication interface allowing for example the control unit to communicate with the solenoid valves, the detectors, the ignition means, etc.

The processor is capable of executing instructions loaded into the RAM from the ROM, from an external memory (not shown), from a storage medium (such as an SD card), or from a communication network. When the equipment is powered up, the processor is capable of reading instructions from the RAM and executing them. These instructions form a computer program that causes the implementation, by the processor, of all or some of the algorithms and steps described.

All or some of the algorithms and steps described below may be implemented in software form by executing a set of instructions using a programmable machine, for example a DSP (digital signal processor) or a microcontroller, or be implemented in hardware form by a machine or a dedicated component, for example an FPGA (field-programmable gate array) or ASIC (application-specific integrated circuit).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A propulsion assembly for an aircraft comprising:
a propulsion system having a core enclosed in a casing and having a combustion chamber,
at least one supply pipe configured to convey dihydrogen to the combustion chamber wherein said at least one supply pipe meanders outside the casing before dropping into the combustion chamber through the casing via at least one injector, and
a housing fastened to the casing in a sealed manner around the casing,
wherein said at least one supply pipe has an upstream part and a downstream part that are fluidically connected to one another through a wall of the housing,
wherein the upstream part is configured to be fluidically connected to a tank and fastened in a sealed manner to said wall of the housing,
wherein the downstream part is housed inside the housing and fastened in a sealed manner to said wall of the housing, and,
wherein the at least one injector is also housed inside the housing.

2. The propulsion assembly according to claim 1, further comprising:
at least one dihydrogen detector arranged in the housing,
a control unit connected to said at least one detector, and
a solenoid valve mounted on the supply pipe and configured to receive commands to open and close from said control unit according to data transmitted to the control unit from said at least one dihydrogen detector.

3. The propulsion assembly according to claim 1, wherein the housing comprises two shells fastened in a sealed manner to one another at a vertical median plane of the propulsion assembly, thus forming a volume between the two shells and the casing.

4. The propulsion assembly according to claim 3, wherein, for each volume, the propulsion assembly comprises an inlet pipe and an outlet pipe that are fluidically connected to said volume,
wherein the inlet pipe is configured to introduce the dinitrogen into said volume, and
wherein the outlet pipe is configured to extract the dinitrogen from said volume.

5. The propulsion assembly according to claim 3, further comprising:
at least one dihydrogen detector arranged in the housing,
a control unit connected to said at least one detector, and
a solenoid valve mounted on the supply pipe and configured to receive commands to open and close from said control unit according to data transmitted to the control unit from said at least one dihydrogen detector,
wherein the propulsion assembly has, for each volume, at least one ignition means housed in said volume and controlled by the control unit so as to generate a spark when a dihydrogen detector of said volume detects dihydrogen.

6. The propulsion assembly according to claim 1, wherein the housing comprises two shells,
wherein each shell is fastened in a sealed manner to the casing at a plane parallel to a vertical median plane of the propulsion assembly, forming, between each shell and the casing, a volume.

7. The propulsion assembly according to claim 1, wherein said or each downstream part is fluidically connected to an upstream part by a plurality of connection zones.

8. The propulsion assembly according to claim 1, wherein the housing is filled with dinitrogen.

9. An aircraft comprising:
a wing,
a dihydrogen tank,
at least one propulsion assembly according to claim 1, and
for each propulsion assembly, a chassis fastening said propulsion assembly to the wing, and
wherein said at least one supply pipe is fluidically connected to the dihydrogen tank.
